(19) United States
(12) Patent Application Publication
(10) Pub. No.: US 2013/0284948 A1
(43) Pub. Date: Oct. 31, 2013

(54) INSULATING-LAYER-CONTAINING CERAMIC MEMBER, METAL-MEMBER-CONTAINING CERAMIC MEMBER, CHARGED PARTICLE BEAM EMITTER, AND METHOD FOR PRODUCING INSULATING-LAYER-CONTAINING CERAMIC MEMBER

(71) Applicant: Kouichi Iwamoto, Omihachiman (JP)

(72) Inventor: Kouichi Iwamoto, Omihachiman (JP)

(73) Assignee: Kyocera Corporation, Kyoto-shi, Kyoto (JP)

(21) Appl. No.: 13/997,522

(22) PCT Filed: Dec. 27, 2011
(86) PCT No.: PCT/JP2011/080322

§ 371 Date: Jun. 24, 2013

(30) Foreign Application Priority Data
Dec. 28, 2010 (JP) 2010-292373
Dec. 28, 2010 (JP) 2010-292374

(51) Int. Cl. H01J 1/02; H01B 13/06

(52) U.S. Cl. CPC H01J 1/02; H01B 13/06
USPC 250/493.1; 174/137 B; 427/58

(57) ABSTRACT

A ceramic member containing an insulating member is disclosed. The ceramic member comprises a ceramic body and an insulating layer on the ceramic body. The ceramic body contains aluminum oxide crystals and aluminum titanate crystals. The insulating layer contains silicon oxide as a main component. The ceramic body includes a first region that includes a first surface portion covered by the insulating layer, and a second region outside the first region, and having a surface resistivity of 1×10⁶ to 1×10⁹Ω/□. A surface resistivity of the first region is higher than the surface resistivity of the second region.

### FIELD OF INVENTION

The present invention relates to an insulating-layer-containing ceramic structure, a metal-part-containing ceramic structure, a charged particle beam emitter, and a method for producing an insulating-layer-containing ceramic structure.

### BACKGROUND

Metal part-containing ceramic components in which a plurality of electrodes are formed on surfaces of a ceramic body are being used in, for example, charged particle beam emitters such as in accelerating components for accelerating charged particles and deflection components for controlling the direction of the charged particles. When a voltage is applied to metal parts of such metal-part-containing ceramic components and the amount of charges that have accumulated between metal parts has become larger than necessary (charging phenomenon), the accumulated charges start flowing all at once, resulting in electron avalanche and generation of a high current, which may result in malfunction of and damage on the accelerating components and the deflection components. Patent Literature 1 (Japanese Unexamined Patent Application Publication No. 2005-190853) proposes a metal-part-containing ceramic component, in which a ceramic body having an appropriate degree of conductivity (semiconductivity) is used in the metal-part-containing ceramic component suitable for use in deflection components. The ceramic component proposed in Patent Literature 1 is a semiconductive ceramic body having a surface resistivity of about 10⁴ to 10¹⁰Ω/□ and containing aluminum oxide (Al₂O₃) that contains titanium (Ti). In particular, in Patent Literature 1, a mixed powder is prepared by mixing powder of aluminum titanate (Al₂TiO₅) with aluminum oxide and then sintered. As a result, a sintered material having a state in which Al₂TiO₅, which is the reaction product with α-alumina, is homogeneously dispersed and dissolved in grain boundaries of aluminum oxide is obtained. Subsequently, the sintered material is fired in a reducing atmosphere and part of homogeneously diffused Al₂TiO₅ is reduced into oxygen-deficient titanium oxide. As a result, a semiconductive ceramic body having a surface resistivity of about 10⁴ to 10¹⁰Ω/□ is obtained.

### SUMMARY

A metal-part-containing ceramic component in which a metal part is provided on a semiconductive ceramic component is used in components to which a relatively high voltage is applied, such as voltage terminals of accelerating tubes for electron sources and insulators for X-ray tubes. The semiconductive ceramic body described in Patent Literature 1 has the entire surface subjected to a reducing treatment and the entire surface exhibits a low surface resistivity of about 10⁴ to 10¹⁰Ω/□. Since the resistivity of the entire surface of the semiconductive ceramic body of Patent Literature 1 is uniformly low, there have been cases in which the amount of electrical current constantly flowing in the ceramic body becomes relatively excessively large. Moreover, according to the semiconductive ceramic body described in Patent Literature 1, the ceramic body after the reducing treatment is exposed to an atmosphere having a relatively low degree of vacuum and thus there have been problems in that the resistivity of the surface is further decreased by the moisture and gas components adhering to the surface of the ceramic body and the leak current occurs easily during application of a high voltage. The present invention has been made to address these problems.

To address these problems, the present invention provides an insulating-layer-containing ceramic structure comprising a ceramic body that contains an aluminum oxide crystal phase and an aluminum titanate crystal phase; and an insulating layer on a surface of the ceramic body, the insulating layer containing silicon oxide as a main component, in which the ceramic body includes a first region that includes a first surface portion covered by the insulating layer and a second region outside the first region, the second region having a surface resistivity of 1×10⁶ to 1×10⁹Ω/□ and a surface resistivity of the first region is higher than the surface resistivity of the second region.

Also provided is a metal-part-containing ceramic structure comprising the insulating-layer-containing ceramic structure mentioned above, a first metal part bonded to the first end surface of the ceramic body, and a second metal part bonded to the second end surface of the ceramic body.

Also provided is a charged particle beam emitter comprising the metal-part-containing ceramic structure mentioned above, charged particle beam emitting means for emitting a charged particle beam that passes through the penetrating hole of the metal-part-containing ceramic structure, and voltage application means for giving a potential difference between the first metal part and the second metal part for accelerating the charged particle beam, the voltage application means being connected to the first metal part and the second metal part.

Also provided is a method for producing an insulating-layer-containing ceramic structure, the method comprising molding a mixture of a first powder containing aluminum oxide as a main component and a second powder containing aluminum titanate as a main component; firing the resulting compact; forming a reduction-suppressing layer that contains silicon oxide as a main component, the reduction-suppressing layer being formed in part of a surface of the fired compact; and reducing, by firing, the fired compact with the reduction-suppressing layer in a reducing atmosphere, whereby an insulating-layer-containing ceramic structure is obtained, the ceramic structure including an insulating layer formed by firing the reduction-suppressing layer and containing silicon oxide as a main component, and a ceramic body that contains an aluminum oxide crystal phase and an aluminum titanate crystal phase, the ceramic body including a first region that includes a first surface portion covered by the insulating layer and a second region outside the first region, the second region having a surface resistivity of 1×10⁶ to 1×10⁹Ω/□, the first region having a surface resistivity higher than that of the second region.

In the insulating-layer-containing ceramic structure, the metal-part-containing ceramic structure, and the charged particle beam emitter according to the present invention, generation of excessive leak current in the surface portion of the ceramic body is suppressed even when a high voltage is applied to the ceramic body. With the method for producing a ceramic structure according to the present invention, a ceramic structure in which generation of excessive leak current in the surface portion of the ceramic body is suppressed can be produced at relatively low cost.

### BRIEF DESCRIPTION OF THE DRAWINGS

FIG. 1(a) is a schematic perspective view of an embodiment of an insulating-layer-containing ceramic structure according to the present invention and FIG. 1(b) is a schematic cross-sectional view of the insulating-layer-containing ceramic structure shown in (a).

FIGS. 2(a) to (c) are schematic cross-sectional views illustrating an embodiment of a method for producing an insulating-layer-containing ceramic structure according to the present invention.

FIG. 3 is a schematic cross-sectional enlarged view of a metal part and nearby portion thereof in the insulating-layer-containing ceramic structure shown in FIG. 1.

FIG. 4 is a schematic cross-sectional view of a charged particle beam emitter that includes an insulating-layer-containing ceramic structure according to the present invention.

FIG. 5 is a schematic cross-sectional view of another example of a ceramic body that has a second region having a surface resistivity of 1×10⁶ to 1×10⁹Ω/□ and a first region having a surface resistivity higher than the surface resistivity of the second region.

FIG. 6 is a schematic cross-sectional view illustrating an embodiment of a method for producing a ceramic body shown in FIG. 5.

### DETAILED DESCRIPTION OF THE PREFERRED EMBODIMENTS

Embodiments of the present invention are described below in detail with reference to the attached drawings.

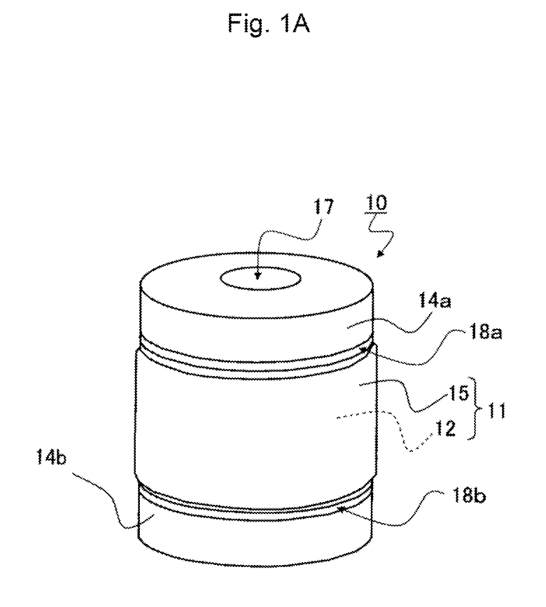

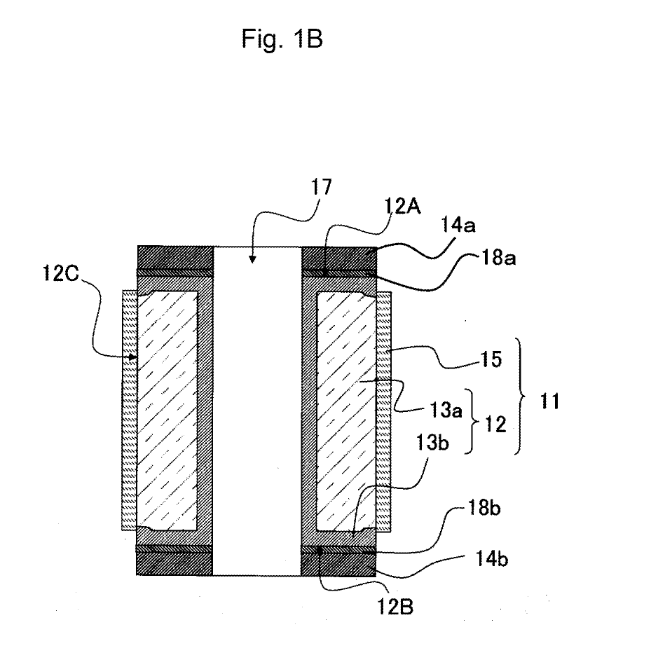

FIG. 1(a) is a schematic perspective view of a component 10 for accelerating charged particles (hereinafter referred to as “accelerating component 10”) which is one embodiment of a metal-part-containing ceramic structure according to the present invention. FIG. 1(b) is a schematic diagram of the accelerating component 10. The accelerating component 10 includes an insulating-layer-containing ceramic structure 11 (hereinafter referred to as a “ceramic structure 11”) which is one embodiment of an insulating-layer-containing ceramic structure according to the present invention, a first metal part 14a, and a second metal part 14b. The ceramic structure 11 includes a ceramic body 12 and an insulating layer 15. The ceramic structure 11 is bonded to the first metal part 14a with a first bonding layer 18a therebetween, and the ceramic structure 11 is bonded to the second metal part 14b with a second bonding layer 18b therebetween.

The ceramic body 12 contains an aluminum oxide crystal phase and an aluminum titanate crystal phase. The ceramic body may further contain at least one oxide of a particular transition element selected from third transition elements (Sc, Ti, V, Cr, Mn, Fe, Co, Ni, Cu, and Zn) and fourth transition elements (Y, Zr, Nb, Mo, Tc, Ru, Rh, Pd, Ag, and Cd) in addition to the aluminum oxide crystal phase.

The ceramic body 12 has a first region 13a covered by the insulating layer 15 and a second region 13b having a surface resistivity of 1×10⁶ to 1×10⁹Ω/□ and lying outside the first region 13a. The surface resistivity of the first region 13a is higher than the surface resistivity of the second region 13b. The ceramic body 12 has a cylindrical shape that includes a first end surface 12A, a second end surface 12B, and a penetrating hole 17 that penetrates between the first end surface 12A and the second end surface 12B. The first region 13a is positioned in an outer peripheral surface 12C of the ceramic body 12 and in a central region between the first end surface 12A and the second end surface 12B. The second region 13b is continuous through an inner peripheral surface of the penetrating hole 17 between the first end surface 12A and the second end surface 12B.

The insulating layer 15 is a layer containing silicon oxide as a main component and has a surface resistivity and a volume resistivity higher than those of the first region 13a. The surface resistivity of the first region 13a and the insulating layer 15 combined is, for example, 1×10¹⁰ to 1×10¹⁴Ω/□ while the first region 13a is covered by the insulating layer 15. Note that the magnitude of the surface resistivity in the description is a value measured with High Resistance Meter 4339B produced by Agilent at an application voltage of DC 1 kV, for example.

The first region 13a and the second region 13b of the ceramic body 12 both have a relatively high surface resistivity. For example, in the cases where a relatively high voltage is applied between the first metal part 14a and the second metal part 14b, the leak current flowing in the surface of the ceramic body 12 is small.

In the ceramic body 12 of this embodiment, the second region 13b having a surface resistivity lower than that of the first region 13a is exposed in the inner surface of the penetrating hole 17 and is continuous through the inner peripheral surface of the penetrating hole 17 between the first end surface 12A and the second end surface 12B of the ceramic body 12. In other words, the second region 13b having an appropriate conductivity is exposed in the entire inner peripheral surface of the penetrating hole 17. The second region 13b is electrically connected to the first metal part 14a at the first end surface 12A and to the second metal part 14b at the second end surface 12B. Thus charges induced by the cations and electrons reaching the inner peripheral surface of the penetrating hole 17 do not stay in the inner peripheral surface of the penetrating hole 17 for a long time, relatively quickly move to the first metal part 14a or the second metal part 14b, and escape from the first metal part 14a or the second metal part 14b as a minute electric current. Thus, for example, when charged particles are allowed to pass through the penetrating hole 17 of the ceramic body 12, the ions and the like generated by the charged particles and reached the inner peripheral surface of the penetrating hole 17 are suppressed from staying there for a long time and accumulation of a large quantity of charges in the inner peripheral surface of the penetrating hole 17 is suppressed.

The first region 13a of the ceramic body 12 is positioned in the outer peripheral surface of the ceramic body 12 of the ceramic body 12 and in a central region between the first end surface 12A and the second end surface 12B. The first region 13a is covered by the insulating layer 15. The accelerating component 10 is used as, for example, an accelerating component of a charged particle beam emitter and for accelerating charged particles by allowing the charged particles to pass through the penetrating hole 17. The outer peripheral surface of the ceramic body 12 is more frequently exposed to an atmosphere with a low degree of vacuum than the inner peripheral surface of the penetrating hole 17. When moisture or gaseous molecules adhere to the outer peripheral surface of the ceramic body 12, the resistivity of that portion is significantly decreased and the leak current may flow through the surface of the first region 13a exposed in the outer peripheral surface. In the ceramic body 12, since the entire first region 13a is covered by the insulating layer 15 and adhesion of impurities such as moisture and gaseous molecules is suppressed, the leak current caused by the moisture and gas is suppressed at the outer peripheral surface.

As described above, the accelerating component 10 that includes the ceramic body 12 can suppress charging of the surface of the ceramic body 12 even when a relatively high voltage is applied between the first metal part 14a and the second metal part 14b and the leak current accompanying the breakdown caused by charging can also be suppressed.

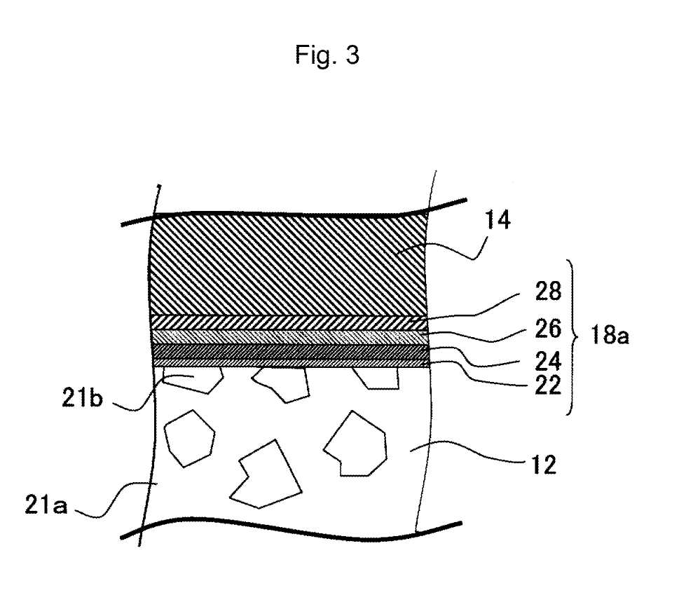

The ceramic body 12 of this embodiment contains 68% to 98% by mass of aluminum (Al) on an Al₂O₃ basis, and 2% to 32% by mass of titanium (Ti) on an oxide basis. The ceramic body 12 contains a crystal phase 21a (refer to FIG. 3) containing aluminum oxide as a main component and a crystal phase 21b (refer to FIG. 3) containing aluminum titanate as a main component. The titanium contained in the aluminum titanate or titanium oxide preferably has an average valence of less than 4. Aluminum titanate and titanium oxide are usually insulators in a completely oxidized state, for example, when they are Al₂TiO₅ and TiO₂. However, the electrical resistance decreases if the valence of titanium is 4 or less (oxygen-deficient titanium oxide) In the ceramic body 12, the first region 13a and the second region 13b contain a crystal phase in which the valence of titanium is 4 or less (oxygen-deficient titanium oxide), and the ceramic body 12 is semiconductive.

The ceramic body 12 more preferably contains α-alumina (aluminum oxide is also referred to as alumina) as a main component and an aluminum titanate crystal phase, Al₂TiO₅₋ₓ (x is greater than 0 and less than 5), which is a semiconductive crystal. In this case, since α-alumina that is resistant to breakdown is contained as a main component, the ceramic body 12 becomes more resistant to breakdown. In order to improve the breakdown resistance, 70% to 85% by mass of α-alumina and 15% to 30% by mass of aluminum titanate, Al₂TiO₅₋ₓ are preferably contained.

The first region 13a and the second region 13b contain different amounts of oxygen-deficient titanium oxides and the oxygen-deficient titanium oxide content is higher in the second region 13b than in the first region 13a. The second region 13b can be formed thorough a heat-treatment in a reducing atmosphere, for example. In other words, a surface portion similar to the first region 13a and formed by molding and firing a mixture of aluminum titanate powder and alumina powder is further heat-treated in a reducing atmosphere to heat-treat Al₂TiO₅ or Al₂TiO₅₋ₓ and increase the percentage of the oxygen-deficient titanium oxides and as a result, the second region 13b can be formed. Since reduction proceeds from the surface toward the inner side, the oxygen-deficient titanium oxide content gradually decreases from the surface of the ceramic body 12 toward the inner side. The oxygen-deficient titanium oxide content can be confirmed by, for example, X-ray diffraction or Auger electron spectroscopy and determining the total of the Ti⁴⁺ content and the Ti³⁺ content in the sintered material.

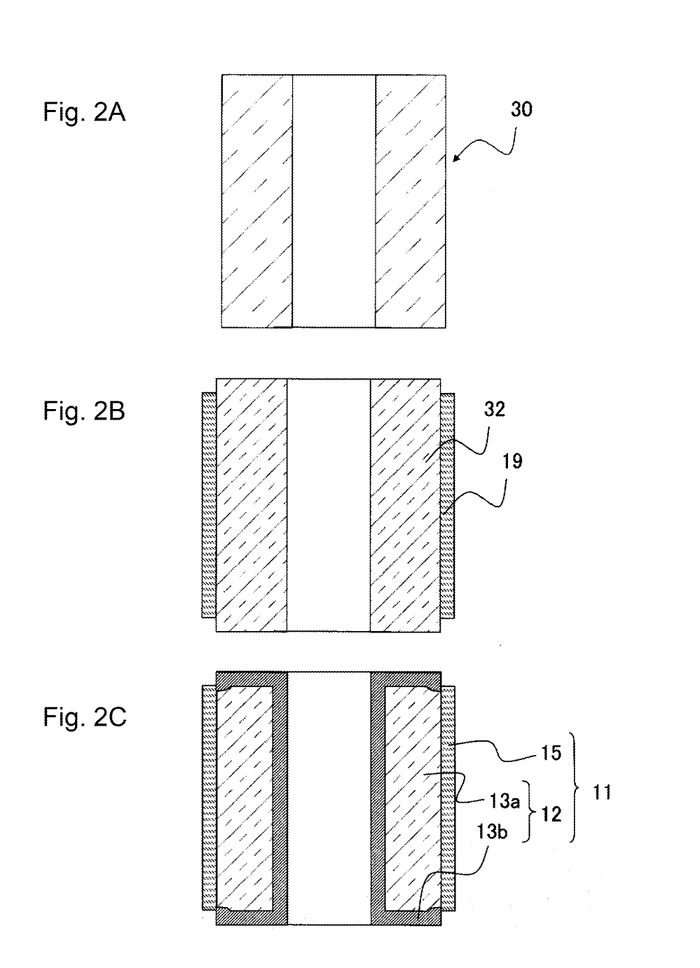

The ceramic structure 11 can be produced as follows, for example. FIG. 2, (a) to (c) are schematic cross-sectional views showing an embodiment of the method for producing the ceramic structure 11. First, 68% to 99% by mass of high-purity alumina powder and 1% to 32% by mass of titanium oxide powder are weighed, mixed together with water in a ball mill, and pulverized. Alumina powder having a purity of 99% by mass or more and an average particle diameter of 0.3 to 1 μm is preferably used as the alumina powder. An organic binder is added to the resulting slurry and the resulting mixture is spray-dried to form granules. The granules are molded by a known method, such as press molding, cold isotactic pressing (CIP), or the like and a green compact 30 having a substantially cylindrical shape shown in FIG. 2(a) is made. The molding pressure is preferably within the range of 80 to 200 MPa at maximum.

Next, the worked green compact is fired at about 1400° C. to 1600° C. and a ceramic sintered compact 32 is formed. The ceramic sintered compact 32 contains an alumina crystal phase and an aluminum titanate crystal phase. During the firing, the temperature increasing rate from the temperature at which the green compact starts to shrink to the maximum temperature and the temperature decreasing rate from the maximum temperature to a temperature at which the grain growth of crystals stops are preferably controlled and the aluminum titanate crystals are preferably dispersed in grain boundaries of alumina crystals. The ceramic sintered compact 32 obtained as such has a transition metal Ti distributed more in the surface than in the inner portion. Next, a glaze which is a precursor of the insulating layer 15 is applied to the surface of the ceramic sintered compact 32 and a reduction-suppressing layer 19 composed of this glaze is formed. The glaze may be, for example, a paste containing high-purity SiO₂ particles and a binder.

The ceramic sintered compact 32 with the reduction-suppressing layer 19 is heat-treated in a reducing atmosphere. During this process, a heat treatment at 1000° C. to 1500° C. is performed in a reducing atmosphere such as hydrogen, nitrogen, or argon. Due to this reducing treatment, as shown in FIG. 2(c), an insulating-layer-containing ceramic structure 11, the structure including an insulating layer 15 (layer formed by firing the reduction-suppressing layer 19 shown in FIG. 2(b)) containing silicon oxide as a main component and a ceramic body 12 that contains an aluminum oxide crystal phase and an aluminum titanate crystal phase can be obtained.

According to this production method of this embodiment, a ceramic body that includes a second region having a surface resistivity of 1×10⁶ to 1×10⁹Ω/□ and a first region which has a surface resistivity higher than that of the second region and is covered by an insulating layer can be produced at relatively low cost.

It should be noted here that the inventor has confirmed that the surface low efficiency of the region coated with the insulating layer 15 is also decreased by re-firing in a reducing atmosphere depending on the conditions. In other words, even when a reduction-suppressing layer such as a glaze layer is formed, the reduction can proceed through the reduction-suppressing layer and the surface resistivity of the region beneath the reduction-suppressing layer can be decreased.

Referring to FIG. 3, the structures of the first bonding layer 18a and the second bonding layer 18b are described. FIG. 3 is an enlarged view of the first bonding layer 18a and its nearby portion. The structure of the second bonding layer 18b is identical to the first bonding layer 18a. In this description, the first bonding layer 18a is described.

The first bonding layer 18a includes a first layer 22, a second layer 24, a third layer 26, and a fourth layer 28. The first layer 22 contains Ti and is bonded to a surface of the ceramic body 12. The second layer 24 containing Ag, Cu, and Ti is disposed on a surface of the first layer 22. The titanium content in the first layer 22 is higher than the titanium content in the second layer 24.

The first layer 22 and the second layer 24 can be formed by a known thick film paste method, for example. In particular, for example, predetermined amounts of silver (Ag) powder, copper (Cu) powder, and titanium (Ti) powder are weighed and mixed with a vehicle prepared by dissolving a binder such as ethyl cellulose with an organic solvent such as terpineol by using a mixer and a paste (Ag—Cu—Ti brazing) is prepared. The first layer 22 and the second layer 24 may be prepared by applying the Ag—Cu—Ti brazing prepared to the first end surface 12A of the ceramic body 12 by screen printing or the like and firing the applied brazing in a vacuum atmosphere. Regarding the blend ratio of the silver powder, the copper powder, and the titanium powder in the paste, for example, 50% to 90% by mass of silver (Ag), 10% to 50% by mass of copper (Cu), and 3.0% to 9.0% by mass of titanium (Ti) are preferably mixed such that the total content of silver (Ag), copper (Cu), and titanium (Ti) is 100% by mass excluding unavoidable impurities.

The Ag—Cu—Ti brazing for forming the first layer 22 and the second layer 24 has a relatively low melting point of 800° C. to 850° C. and thus the temperature at which the first layer 22 and the second layer 24 are formed can be suppressed to a relatively low level. When the first layer 22 and the second layer 24 are formed by using the Ag—Cu—Ti brazing, it becomes possible to form brazing layers at a sufficiently low temperature relative to the firing temperature of the ceramic body 12.

In the accelerating component 10, the titanium content in the first layer 22 is higher than the titanium content in the second layer 24. The first layer 22 is a layer in which the titanium component in the Ag—Cu—Ti brazing formed on a surface of the ceramic body 12 and the titanium component contained in the ceramic body 12 are found in high concentrations at the border portion between the ceramic body 12 and the Ag—Cu—Ti brazing. The first layer 22 that contains titanium as a main component exhibits high bonding strength to the ceramic body 12. Due to the first layer 22 containing titanium, the bonding strength between the ceramic body 12 and a metal part 14 is enhanced. the second layer 24 is a layer formed by co-firing with the first layer 22 and the titanium content is relatively low because the titanium component in the paste segregates in the first layer 22.

The ceramic body 12 of this embodiment contains an aluminum titanate crystal phase 21b. The aluminum titanate crystal phase 21b is also exposed in the surface of the ceramic body 12. In other words, the crystal phase 21b is exposed at the interface between the ceramic body 12 and the first layer 22. The titanium (Ti) component abundant in the first layer 22 bonds with the aluminum titanate crystal phase 21b. In the accelerating component 10, the aluminum titanate crystal phase 21b at the first end surface 12A of the ceramic body 12 smoothly bonds with titanium in the first layer 22 and the ceramic body 12 is strongly bonded to the first layer 22.

The titanium content in the first layer 22 is 6% to 12% by mass. The titanium content (% by mass) is, for example, determined by a known EDS (energy dispersive X-ray spectroscopy) that uses a scanning electron microscope system, for example. For example, a spectrum corresponding to each atom is determined with PHOENIX produced by EDAX at an acceleration voltage of 15 kV and the titanium content can be calculated from the spectrum intensity corresponding to the atom. The third layer 26 contains nickel (Ni) as a main component, for example. Transition metals such as titanium have high reactivity and form compounds by reacting with plating materials such as nickel, gold, and copper. When the surface of the second layer 26 is plated with Ni, titanium contained in the first layer is also contained in the third layer 26 and forms a bonding layer containing a titanium compound as a main component at the interface between the second layer 24 and the third layer 26. The third layer 26 is relatively strongly bonded to the second layer 24 due to this bonding. The third layer may be formed by not only nickel plating but also gold plating, copper plating, or the like. The third layer may contain titanium and at least one selected from nickel, copper, and gold.

The fourth layer 28 is made with a Ag—Cu—Ti brazing layer that contains 50% to 90% by mass of silver (Ag), 10% to 50% by mass of copper (Cu), and 3% to 9% by mass of titanium (Ti). Nickel contained in the third layer 28 reacts with titanium contained in the fourth layer 28 and forms a compound, and the third layer 26 and the fourth layer 28 are strongly bonded.

The Ag—Cu—Ti brazing constituting the fourth layer 28 has a relatively low melting point of 800° C. to 850° C. and the temperature for forming the fourth layer 28 can be suppressed to a relatively low level. When a Ag—Cu—Ti brazing is used as the fourth layer 28, a brazing layer can be formed at a sufficiently low temperature relative to the firing temperature of the ceramic body 12 and fluctuation of the mechanical strength and the electrical conductivity of the ceramic body 12 during a brazing step can be suppressed. Note that the brazing constituting the first layer 22 and the fourth layer 28 is not limited to the Ag—Cu—Ti brazing described above. For example, Ag—Cu brazing, Cu brazing, Ag—Pd brazing, Au—Cu brazing, Au—Pd brazing, Pt—Cu brazing, Pt—Pd brazing, Al brazing, Au—Sn brazing, Ag—Cu—In brazing, Cu—Ti brazing, Ag—Pd—Ti brazing, Pt—Cu—Ti brazing, Pt—Pd—Ti brazing, or the like may be used. In the accelerating component 10 of this embodiment, the electrodes 14a and 14b are bonded to the ceramic body 12 at a relatively high bonding strength.

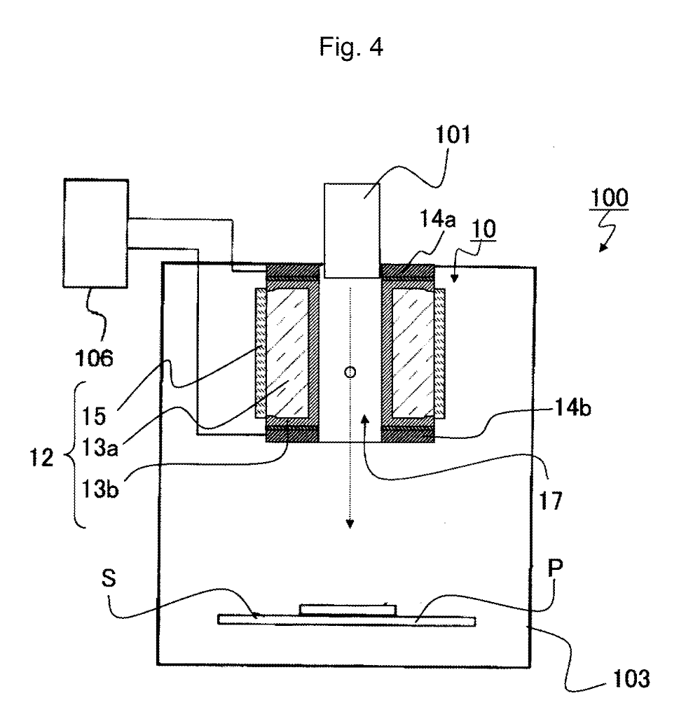

FIG. 4 is a schematic cross-sectional view illustrating an embodiment of a charged particle beam emitter according to the present invention. As shown in FIG. 4, a charged particle beam emitter 100 includes an accelerating component 10, charged particle beam emitting means 101 that emits a charged particle beam that passes through a penetrating hole 17 of the accelerating component 10, and voltage application means 106 which is connected to a first metal part 14a and a second metal part 14b of the accelerating component 10 and gives a potential difference between the first metal part 14a and the second metal part 14b for accelerating the charged particle beam. At least part of the charged particle beam emitting means 101 and the accelerating component 10 are disposed inside a container 103. The container 103 is, for example, a vacuum chamber and an object P is placed at a position where the charged particles reach inside the container 103. The object P may be placed on a stage S, for example. The charged particle beam emitting means 101 is, for example, a known electron gun and the accelerating component 10 accelerates electrons emitted from the charged particle beam emitting means 101 by using a voltage applied between the electrodes 14a and 14b.

In the accelerating component 10, the first region 13a and the second region 13b of the ceramic body 12 have a relatively high volume resistivity and generation of leak current flowing inside the ceramic body 12 is suppressed even when a relatively high voltage is applied between the electrode 14a and the electrode 14b, for example. Moreover, the first region 13a and the second region 13b have a relatively high surface resistivity and the leak current flowing in the surface of the ceramic body 12 is suppressed even when a relatively high voltage is applied between the electrode 14a and the electrode 14b.

In the accelerating component 10, the insulating layer 15 is attached to the outer surface of the ceramic body 12 and adhesion of impurities such as moisture and gaseous molecules to the outer surface of the ceramic body 12 is suppressed. In the accelerating component 10, the leak current in the surface (outer surface) of the ceramic body 12 caused by moisture and gas is also suppressed.

In such a charged particle beam emitter, electrons and cations ionized by the charged particle beam passing in the penetrating hole 17 of the ceramic body 12 sometimes reach the inner peripheral surface of the penetrating hole 17 of the ceramic body 12. If the inner peripheral surface of the penetrating hole 17 is composed of high-purity alumina, for example, and has an excessively high surface resistivity, the cations and electrons that have reached the inner peripheral surface become immobile and charged and a high current may flow toward the electrode side all at once when a particular amount of charges are accumulated. In the charged particle beam emitting means 101, a second region having a relatively low surface resistivity of 1×10⁶ to 1×10⁹Ω/□ is arranged at the inner peripheral surface of the penetrating hole 17 of the ceramic body 12 and thus the surface of the ceramic body 12 is suppressed from becoming charged. The charged particle beam emitter 100 that includes this ceramic body 12 suffers less malfunction caused by leak current at the surface and excessively high current occurring due to charging phenomena.

The charged particle beam emitter 100 can be used as an electron gun of an electron microscope or an electron gun of an electron beam exposure device, for example. Moreover, the insulating-layer-containing ceramic structure according to the present invention can be used in various devices to which a relatively high voltage is applied, such as an insulators for X-ray tubes, insulators for vacuum switches, and electrostatic deflection components for controlling the direction of charged particle beams. Even if the structure is used in usage that involves application of a relatively high voltage as such, the device is resistant to breakdown and the operation reliability of the device can be enhanced. The arrangement and shape of the first region and the second region in the ceramic structure can be appropriately set in accordance with the voltage distribution applied and the position where generation of current is desirably suppressed.

Next, a metal-part-containing ceramic structure 111 with a metal part (hereinafter referred to as ceramic structure 111) that uses a ceramic body 112 and a method for producing the ceramic structure 111 are described. The ceramic structure 111 is another example of a ceramic body that has a second region that has a surface resistivity of 1×10⁶ to 1×10⁹Ω/□ and a first region that has a surface resistivity higher than the surface resistivity of the second region.

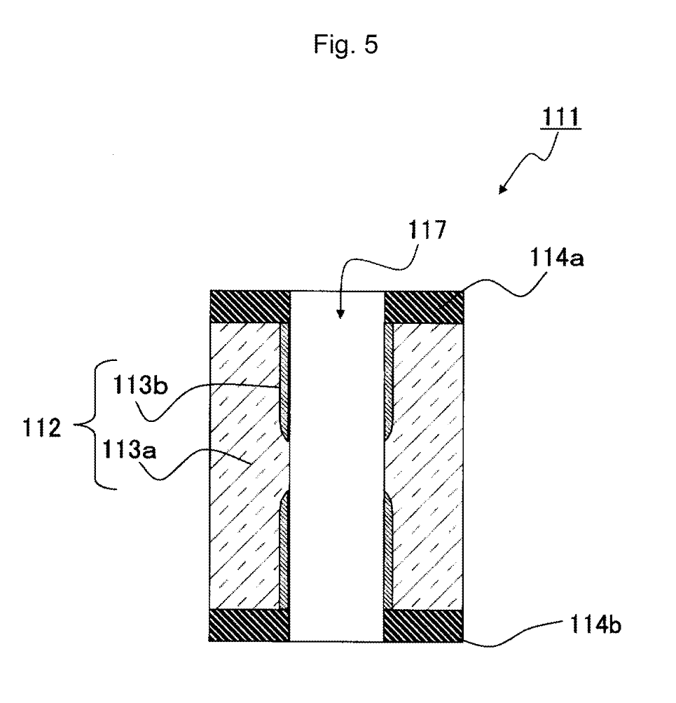

FIG. 5 is a schematic cross-sectional view of the ceramic structure 111. The ceramic structure 111 includes the ceramic body 112, a first metal part 114a bonded to a first end surface 112A of the ceramic body 112, and a second metal part 114b bonded to a second end surface 112B of the ceramic body 112.

As with the ceramic body 12 of the aforementioned embodiment, the ceramic body 112 contains an aluminum oxide crystal phase and an aluminum titanate crystal phase. The ceramic body 112 has a first region 113a having a surface resistivity of 1×10¹⁰ to 1×10¹⁴Ω/□ and second regions 113b having a surface resistivity of 1×10⁶ to 1×10⁹Ω/□.

The second regions 113b lie at two end portions of the inner peripheral surface of a penetrating hole 117 of the ceramic body 112. The first region 113a lies in a central region of the inner peripheral surface of the penetrating hole 117 of the ceramic body 112 and between the first end surface 112A and the second end surface 112B. In the inner peripheral surface of the penetrating hole 117 of the ceramic body 112, the second region 113b on the first end surface 112A side is separated by the first region 113a from the second region 113b on the second end surface 112B side. In this example, compared to the case where the entire inner peripheral surface of the penetrating hole 117 is constituted by the second region 113b, the leak current that constantly flows when a voltage is applied between the first metal part 114a and the second metal part 114b is decreased.

Electrons and cations ionized by the charged particle beam passing in the ceramic body 112 sometimes reach the inner peripheral surface of the penetrating 117 of the ceramic body 112 such as in the case where the ceramic body 112 is used as an accelerating component of a charged particle beam emitter. If the inner peripheral surface of the penetrating hole 117 is composed of high-purity alumina and the surface resistivity is excessively high, the cations and electrons that have reached the inner peripheral surface become immobile and charged and a high current may flow toward the electrode side all at once when a particular amount of charges are accumulated. In the ceramic body 112 of this example, the first region 113a having a surface resistivity of 1×10¹⁰ to 1×10¹⁴Ω/□ and the second regions 113b having a surface resistivity of 1×10⁶ to 1×10⁹Ω/□ are exposed in the inner peripheral surface of the penetrating hole 117 and thus the inner peripheral surface has an appropriate degree of electrically conductivity. Accordingly, the charges induced by the cations and electrons that have reached the inner peripheral surface of the penetrating hole 117 do not stay there for a long time, relatively quickly move to the second metal part 114b, and escape from the first metal part 114a or the second metal part 114b as a minute electric current. The charges do not move as easily in the first region 113a having a surface resistivity of 1×10¹⁰ to 1×10¹⁴Ω/□ as in the second regions 113b having a surface resistivity of 1×10⁶ to 1×10⁹Ω/□. However, since the first metal part 114a is adjacent to the second regions 113b in the inner peripheral surface of the ceramic body 112, the charges in the first region 113a can escape relatively quickly through the adjacent second regions 113b compared to when the entire inner peripheral surface of the penetrating hole 117 is covered by the first region 113a.

As described above, the leak current flowing in the surface of the ceramic body 112 is suppressed even when a relatively high voltage is applied between the first metal part 114a and the second metal part 114b and the surface of the ceramic body 112 is suppressed from becoming charged. With this ceramic body 112, malfunctions caused by excessively high currents generated by charging phenomena and the leak current at the surface are relatively less frequent.

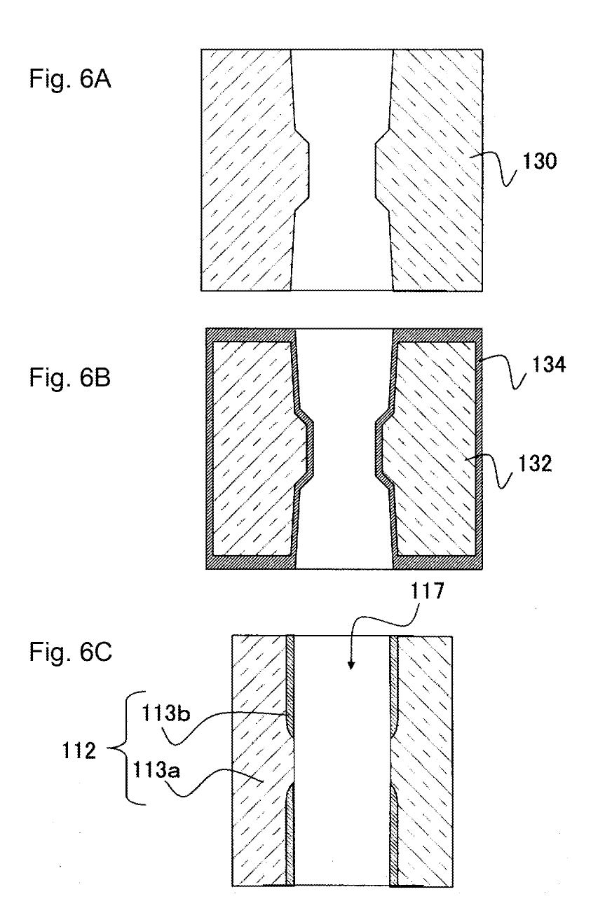

FIGS. 6, (a) to (c) are schematic cross-sectional views illustrating a method for producing the ceramic body 112. First, for example, 68% to 99% by mass of high-purity alumina powder and 1% to 32% by mass of titanium oxide powder are weighed, mixed together with water in a ball mill, and pulverized. Alumina powder having a purity of 99% by mass or more and an average particle diameter of 0.3 to 1 μm is preferably used as the alumina powder. An organic binder is added to the resulting slurry and the resulting mixture is spray-dried to form granules. The granules are molded by a known method, such as press molding, cold isotactic pressing (CIP), or the like and a green compact 130 having a substantially cylindrical shape and a penetrating hole that has a protruding portion near the center portion of the inner peripheral surface of the penetrating hole is formed by this molding. The molding pressure is preferably within the range of 80 to 200 MPa at maximum.

Next, the worked green compact is fired at about 1400° C. to 1600° C. and a ceramic sintered compact is formed. The ceramic sintered compact contains an alumina crystal phase and an aluminum titanate crystal phase. During the firing, the temperature increasing rate from the temperature at which the green compact starts to shrink to the maximum temperature and the temperature decreasing rate from the maximum temperature to a temperature at which the grain growth of crystals stops are preferably controlled and the aluminum titanate crystals are preferably dispersed in grain boundaries of alumina crystals. The sintered compact obtained as such has a transition metal Ti distributed more in the surface than in the inner portion.

The alumina-aluminum titanate sintered compact is then heat-treated in a reducing atmosphere. In other words, a heat treatment at 1000° C. to 1500° C. is conducted through a heat treatment in a firing furnace in a reducing atmosphere such as hydrogen, nitrogen, or a HIP treatment. As a result of this reducing treatment, as shown in FIG. 6(b), a reduced layer 134 corresponding to the second region that has a surface resistivity lower than an inner portion 132 is formed on the entire surface. The sintered compact has a protruding portion in the inner peripheral surface of the penetrating hole as with the green compact and the surface of the protruding portion is also reduced by the reducing treatment.

The resulting sintered compact is mechanically polished and the ceramic body 112 shown in FIG. 6(c) can be obtained as a result. In this embodiment, the entire outer peripheral surface is polished and the inner surface is mechanically polished by, for example, inner surface homing. In a cross-sectional view, the border portions between the surface of the first region 113a and the surfaces of the second regions 113b are flat and a cylindrical ceramic body 112 is formed. Due to this polishing, the reduced layer portion covering the protruding portion formed in the inner peripheral surface is removed and the region in which the reduction is not sufficiently progressed is exposed in the inner peripheral surface of the penetrating hole 117.

According to the production method of this example, a ceramic body in which the first region 113a having a surface resistivity of 1×10¹⁰ to 1×10¹⁴Ω/□ and second regions 113b having a surface resistivity of 1×10⁶ to 1×10⁹Ω/□ lie in desired positions can be produced at relatively low cost. Moreover, according to the production method of this example, the titanium (Ti) contents and the oxygen-deficient titanium oxide contents in the first region 113a and the second regions 113b can be controlled by controlling the shape of the green compact 130, the thickness of the reduced layer 134, and the amount of polishing, and thus it becomes possible to adjust the surface resistivity and volume resistivity of each region to be in the desired ranges.

While the present invention is described above in terms of an insulating-layer-containing ceramic structure, a metal-part-containing ceramic structure, a charged particle beam emitter, and a method for producing an insulating-layer-containing ceramic structure, the present invention is not limited by these embodiments and various modifications and alterations are possible without departing from the scope of the present invention.

### REFERENCE SIGNS LIST

10 charged particle-accelerating component
11 insulating-layer-containing ceramic structure
12 ceramic body
12A first end surface
12B second end surface
13a first region
13b second region
14a first metal part
14b second metal part
15 insulating layer
17 penetrating hole
18a first bonding layer
18b second bonding layer
22 first layer
24 second layer
26 third layer
28 fourth layer
32 ceramic sintered compact

1. An insulating-member-containing ceramic member comprising:
a ceramic body that contains an aluminum oxide crystal phase and an aluminum titanate crystal phase; and
an insulating layer on a surface of the ceramic body, and containing silicon oxide as a main component,
wherein the ceramic body comprises:
a first region that includes a first surface portion covered by the insulating layer; and
a second region outside the first region, and having a surface resistivity of 1×10⁶ to 1×10⁹Ω/□, and
wherein a surface resistivity of the first region is higher than the surface resistivity of the second region.

2. The insulating-member-containing ceramic member according to claim 1, wherein the ceramic body has a cylindrical shape comprising a first end surface, a second end surface opposing to the first end surface, and a penetrating hole penetrating between the first end surface and the second end surface;
the first region lies in a central region of an outer peripheral surface of the ceramic body and between the first end surface and the second end surface; and
the second region is continuous through an inner peripheral surface of the penetrating hole between the first end surface and the second end surface of the ceramic body.

3. The insulating-member-containing ceramic member according to claim 1, wherein the ceramic body contains an oxygen-deficient titanium oxide which is an aluminum titanate crystal phase having an oxygen content lower than a chemical equivalent thereof and the oxygen-deficient titanium oxide is contained in a larger amount in the second region than in the first region.

4. The insulating-member-containing ceramic member according to claim 1, wherein a volume resistivity of the first region is larger than a volume resistivity of the second region.

5. The insulating-member-containing ceramic member according to claim 1, wherein an amount of the oxygen-deficient titanium oxide at a surface of the second region is higher than an amount of the oxygen-deficiency oxide at an inside of the second region.

6. A metal-member-containing ceramic member comprising:
the insulating-member-containing ceramic structure according to claim 2;
a first bonding layer on the first end surface of the ceramic body;
a first metal member bonded to the first end surface with the first bonding layer therebetween;
a second bonding layer adhering to the second end surface of the ceramic body; and
a second metal member bonded to the second end surface with the second bonding layer therebetween.

7. A charged particle beam emitter comprising:
the metal-member-containing ceramic structure according to claim 6;
charged particle beam emitting member for emitting a charged particle beam that passes through the penetrating hole of the metal-member-containing ceramic structure; and
voltage application member for giving a potential difference between the first metal member and the second metal member for accelerating the charged particle beam, the voltage application member being connected to the first metal member and the second metal member.

8. A method for producing an insulating-member-containing ceramic member, the method comprising:
molding a mixture of a first powder containing aluminum oxide as a main component and a second powder containing aluminum titanate as a main component;
firing a resulting compact;
forming a reduction-suppressing layer that contains silicon oxide as a main component, the reduction-suppressing layer being formed in part of a surface of the fired compact; and
reduction-firing, an obtained fired body having the reduction-suppressing layer in a reducing atmosphere to obtain an insulating-member-containing ceramic member, the ceramic member comprising:
a ceramic body that contains an aluminum oxide crystal phase and an aluminum titanate crystal phase; and
an insulating layer on a surface of the ceramic body, and containing silicon oxide as a main component,
wherein the ceramic body comprises:
a first region that includes a first surface portion covered by the insulating layer; and
a second region outside the first region, the second region having a surface resistivity of 1×10⁶ to 1×10⁹Ω/□, and
wherein a surface resistivity of the first region is higher than that of the second region.
